(19) United States
(12) Patent Application Publication
(10) Pub. No.: US 2026/0017165 A1
(43) Pub. Date: Jan. 15, 2026

(54) MONITOR CONTROL AND ANALYSIS AGENTS COUPLED TO MULTIPLE SUBBLOCKS OF A SYSTEM-ON-CHIP (SOC)

(71) Applicant: HEWLETT PACKARD ENTERPRISE DEVELOPMENT LP, Spring, TX (US)

(72) Inventors: NAYSEN J. ROBERTSON, Roseville, CA (US); Emily Dalton, Spring, TX (US); Samuel Gonzalez, Spring, TX (US)

(21) Appl. No.: 18/771,078

(22) Filed: Jul. 12, 2024

(51) Int. Cl. G06F 11/34

(52) U.S. Cl. CPC G06F 11/3409

(57) ABSTRACT

Examples of the application describe Monitor Control and Analysis Agents (MCAA) coupled to multiple subblocks on the System on Chip (SoC) to help enable monitoring and potential execute countermeasures near the point-of measurement of silicon-level components of a chip (e.g., of an application-specific integrated circuit or ASIC) in real time.

### BACKGROUND

Silicon chips are increasingly more complex with less space available for the complexities. The chips are often pushed to the physical limitations of the chip to try to increase the density of subblocks on the chip while also increasing the abilities of the existing subcomponents.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a chain ring framework around an example of a SoC with multiple subblocks coupled to multiple monitor control and analysis agents (MCAAs), in accordance with some examples of the disclosure.

FIG. 2 illustrates a SoC with multiple subblocks coupled to multiple MCAAs, in accordance with some examples of the disclosure.

FIG. 3 illustrates a single subblock coupled to a single MCAA of a SoC, in accordance with some examples of the disclosure.

FIG. 4 is a summary of function utilization using MCAA tracking of the subblock operations, in accordance with some examples of the disclosure.

FIG. 5 is an illustrative computing component that may be used to implement various features of examples described in the present disclosure.

FIG. 6 is an illustrative computing component that may be used to implement various features of examples described in the present disclosure.

FIG. 7 is an illustrative computing component that may be used to implement various features of examples described in the present disclosure.

FIG. 8 is an example computing component that may be used to implement various features of examples described in the present disclosure.

The figures are not exhaustive and do not limit the present disclosure to the precise form disclosed.

### DETAILED DESCRIPTION

In traditional systems, a System-on-Chip (SoC) may comprise multiple subblocks to execute operations by silicon-level components of the chip. Subblocks may comprise, for example, components or features of the SoC, including a debug client, function, interface, or other silicon-level feature embedded with the chip. Each of the subblocks may comprise “mission-mode” execution logic to operate in a default or standard operation mode.

Various examples are described throughout the application to improve the traditional systems. For example, Monitor Control and Analysis Agents (MCAAs) may be coupled to multiple subblocks on the SoC to help enable monitoring of silicon-level components of a chip (e.g., of an application-specific integrated circuit or ASIC) in real time. In other words, a single MCAA may be coupled to a single subblock, and the coupling may be repeated for multiple different MCAAs and subblocks on a SoC.

In some examples, the MCAAs may be placed relative to or adjacent to their associated subblock to facilitate non-intrusive observability, embedded analytics, and provide near data processing. In some examples, the MCAAs are configured and monitored through a Control and Status Register (CSR) subblock that connects to the SoC fabric. In other examples, the MCAAs are autonomous and individually programmable so that they can implement different optional capabilities as required by the specific SoC function(s) to which they associate.

Various implementations of the MCAAs are possible. For example, the coupled MCAAs/subblocks may be organized in a chain ring framework around the SoC to effectively execute different tasks at the subblock level. The ring format may transmit signals between the ring internodes that connects the subblocks and aggregates the region-local signals to form advanced analytics on signals from the individual subblocks.

Various actions may be executed based on the coupled MCAAs/subblocks to improve the overall capabilities of the SoC. For example, the MCAA/subblocks may be implemented for an improved debugging/error detection process of the SoC. The individual testing can be performed on subblocks of the SoC without interfering with the standard processing of the subblocks. For example, one or more MCAA may be instructed to detect and monitor parametric performance data on the SoC subblocks (e.g., internal parametric telemetry data). Parametric performance data may comprise, for example, parameters or other use metrics that are quantifiable and measurable at the silicon-level, including time, cost, resource utilization (e.g., power, memory, etc.), and other measurable aspects of the performance of the subblock. In some examples, the parametric performance data is provided to the processor from the set of MCAAs to generate a heat map, a time-series utilization curve, or other analytics of usage of the subblock.

The coupling of the MCAA with the subblock may help the MCAA gain runtime access to any subset of monitored signals without disrupting the subblock's “mission-mode” processing/execution logic (e.g., default or standard operation). This can allow the MCAA to monitor and interpret parametric performance data. In other words, the MCAAs may be incorporated with the framework as leaves of the subblock that can individually execute processing independent of the functions executed in “mission-mode” operation. This allows the MCAAs to determine capabilities and runtime utilization of each subblock without directly impacting the processing capabilities of the subblock.

The monitoring can be used to determine use metrics of the subblock that are used to generate, for example, full-chip insights, resource bottlenecks, long dwell usage, and efficiency statistics. New processing can be assigned based on this analysis. Various actions can be taken based on the monitoring, including processes that implement identifications and predictions of chip hot-spots or underutilized circuits. In some examples, the action to be taken comprises a trigger process that can arm a trigger set to launch processes when an associated threshold value is reached, for example for localized frequency scaling or duty cycle modulation (DCM). In some examples, the trigger process is initiated, by the individual MCAAs, to autonomously execute or independently execute localized frequency scaling or DCM. In some examples, the action to be taken comprises enabling external voltage scaling. The prediction process, for example, can be initiated based on determining that the summary of usage of the use metric comprises a resource bottleneck, long dwell usage, or an efficiency statistic of the individual subblock.

In some examples, multiple MCAAs can run in parallel and provide use/utilization metrics at runtime. These metrics can be used to generate a map of data processing and other activity. In some examples, the data may be stored and compared across time frames, including past and present comparisons or future predictions.

In some examples, the MCAA/subblocks may be utilized to help monitor a pay-for-use of the SoC overall or portions of the SoC, including per-function use levels of the SoC. This analysis/finding can be implemented in a service-based model. For example, clients can pay for use of individual chip components, rather than at less granular full-chip quanta. With this finer granularity of pay-for-use monitoring and control, a job schedular can direct pending requests to the most underutilized chip within the pool of available devices and resources, and it may do so using a function-specific context based on the job requirements/criteria.

In some examples, the MCAA/subblocks may track power usage at a subblock level and identify subblock power usage or function-based power usage. For example, the MCAA framework may determine, (1) where power is being consumed within the SoC and (2) which embedded functions are most utilized, or how to characterize the utilization over time of disparate SoC functions (e.g., Ethernet Direct Memory Access (DMA) performance through data path bottlenecks) whilst concurrent processes are executed (e.g., while video frame buffer accesses to the local Dynamic RAM (DRAM) are in flight).

Using the above-noted information, a controller may instruct the MCAA(s) to disable one or more associated functions, or the MCAA may independently execute operations to disable various functions. The MCAA accomplishes this through assertion of clock-gating elements and/or disablement of register enable pins. Some implementations allow power wells to be disabled in a similar fashion, intelligently reducing device power utilization by dynamically culling unused functional branches.

Various improvements to technology may be realized based on the improved framework. For example, the improved framework may couple autonomous MCAAs to multiple subblocks for the SoC to perform various autonomous actions with the chip/subblocks, including (1) an improved debugging/error detection process of the SoC, (2) an improved function utilization process of SoC subblocks (for pay-for-use monetization of subfunctions), and (3) an improved power usage process of SoC subblocks, to name a few.

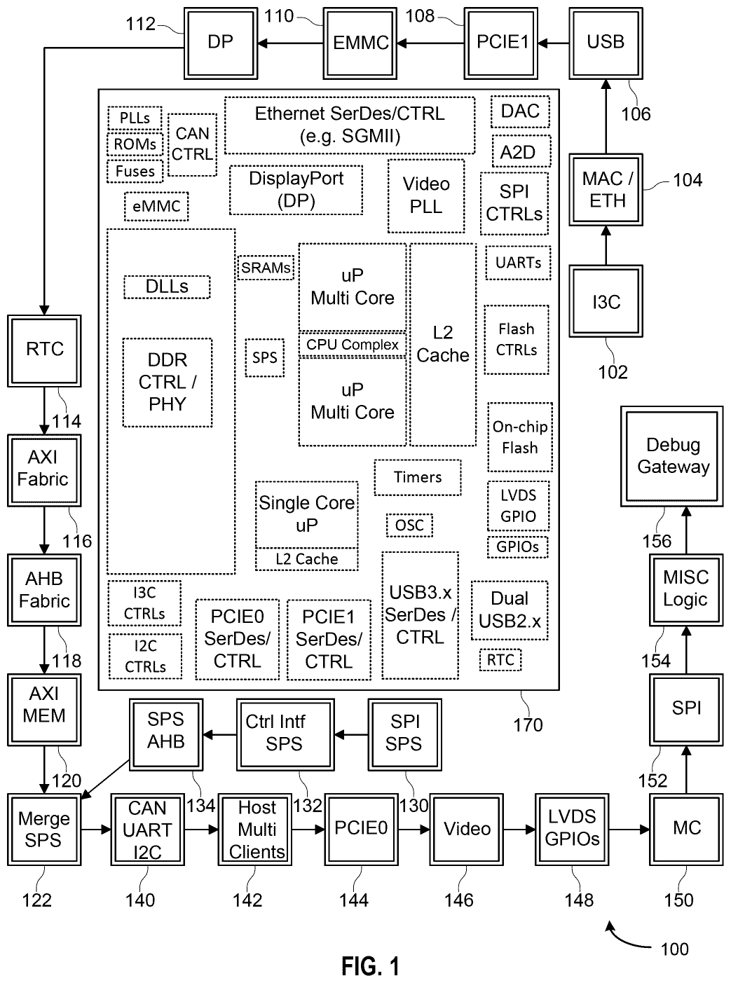

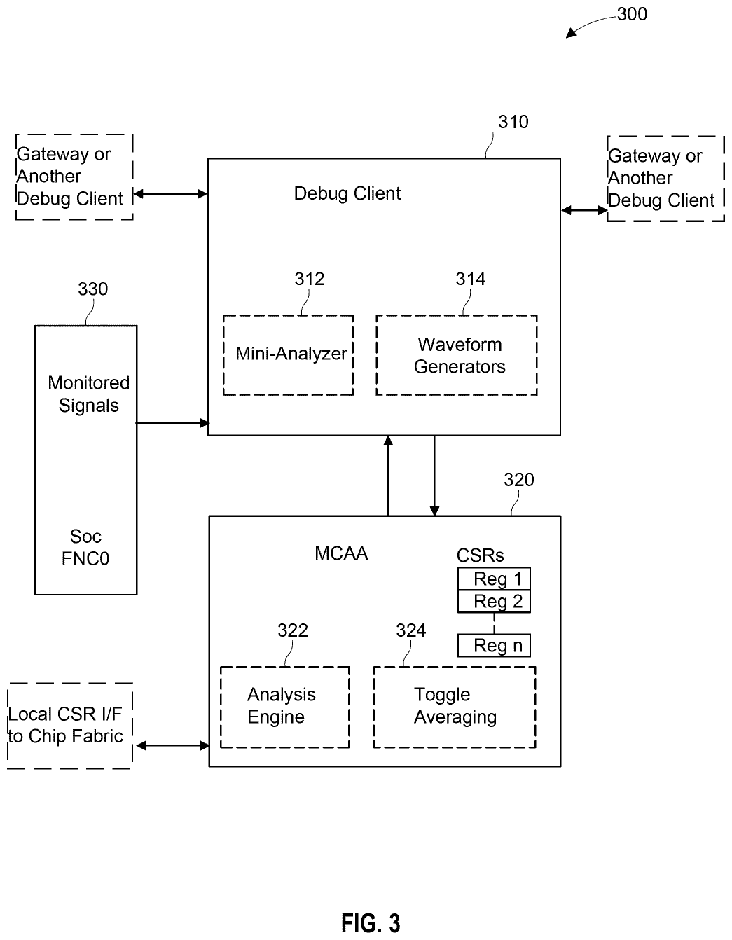

FIG. 1 illustrates a chain ring framework around an example of a SoC with multiple subblocks coupled to multiple function-specific MCAA and debug client nodes, in accordance with some examples of the disclosure. In example 100, a set of functions is illustrated as subblocks, where the block illustrated comprises a debug client 310, MCAA 320, and function 330 as illustrated in FIG. 3.

Various subblocks are available and can be implemented in a physical silicon device using a layout, such as the layout illustrated in FIG. 1. The subblocks in FIG. 1 can be coupled with MCAA (not shown). Alternate layouts and constructions of the subblocks are available without diverting from the essence of the disclosure.

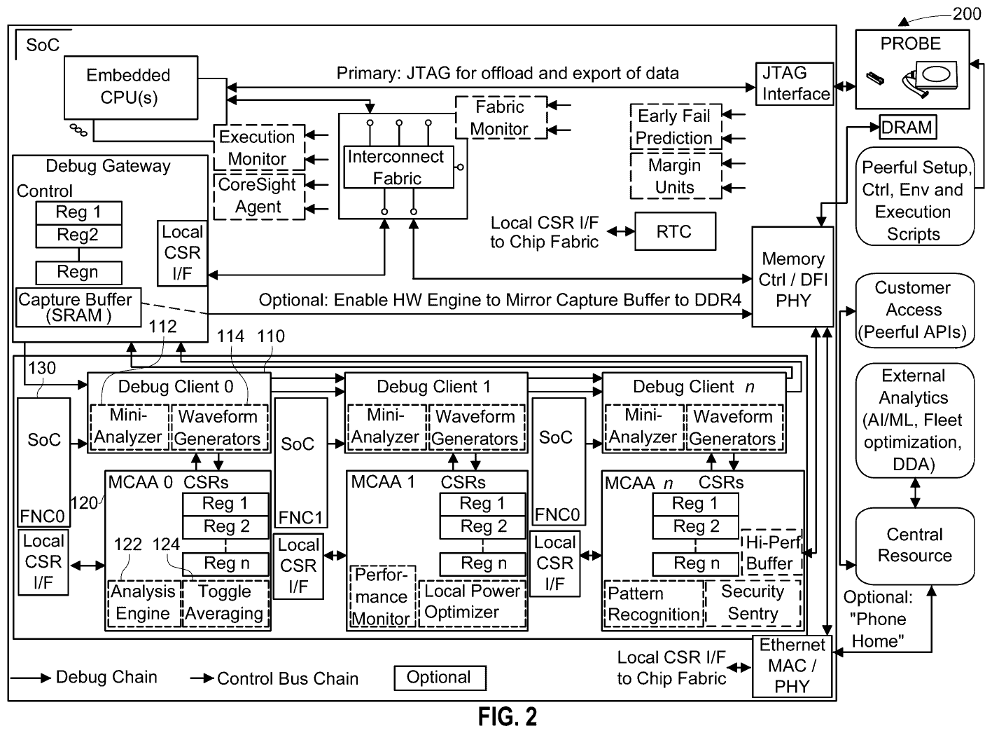

The illustrated subblocks include Inter-Integrated Circuit (e.g., I2C or I3C) Controller 102, Media Access Controller (MAC)/Ethernet subsystem (ETH) 104, Universal Serial Bus (USB) 106, Peripheral Component Interconnect Express 1 (PCIe1) 108 (e.g., PCIe Controller-Endpoint or RootPort instance-1), Embedded MultiMediaCard (EMMC) 110, DisplayPort (DP) subsystem 112, Real Time Clock (RTC) 114, Advanced extensible Interface (AXI) protocol interconnect fabric 116, Advanced High-Performance Bus (AHB) protocol interconnect fabric 118, AXI MEM 120 (associated with AXI interconnect fabric 116), Subsidiary chain merge node for the Security Processor Subsystem Merge (SPS Merge) 122, Serial Peripheral Interface for the Security Processor Subsystem (SPI SPS) 130, Control/Status Interface for the Security Processor Subsystem (Ctrl Intf SPS) 132, AHB interconnect fabric for the Security Processor Subsystem (SPS AHB) 134, Inter-Integrated Circuit (I2C) Universal Asynchronous Receiver Transmitter (UART) Controller Area Network (CAN) 140, host-related functions/subsystems 142, Peripheral Component Interconnect Express 0 (PCIe0) 144 (e.g., PCIe Controller-Endpoint or RootPort instance-0), Video Graphics Controller subsystem (Video) 146, Low Voltage Differential Signaling (LVDS) general-purpose input/output (GPIO) 148, Memory Controller (MC) 150, Serial Peripheral Interface (SPI) 152 (e.g., SPI controller and related subsystem), miscellaneous logic (MISC logic) 154, Debug Gateway (DBG) 156 (e.g., the end of the serial debug/MCAA chain), and SoC 170. In some examples, SoC 170 may be implemented as a System on Chip (SoC), integrated-circuit microchip, programmable logic device, or Application-Specific Integrated Circuit (ASIC). Additional detail of these subblocks and functions are shown in FIG. 2 and FIG. 3.

The subblocks may be organized as a chain ring framework around the SoC 170 and end with debug gateway 156. The chain ring format may transmit signals sequentially from subblock to subblock, via each debug-client/MCAA node complex (not shown in FIG. 1). In some examples, the debug clients from each subblock may be communicatively coupled to transmit information in the ring around the SoC. The selected subset of signals may be parsed/chopped into smaller groups and funneled onto the chain ring that serially connects to the debug client subblocks for each of the functions spread across the chip. In this way, one may aggregate a subset of signals from subblock X with an independent set of signals from subblock Y or a combination of selected subblocks n.

In some examples, the nodes may be a “pass-through” node or an “activated” node. The pass-through node may allow data to be transmitted through the node absent analysis or adjustment of the data. The activated node may access the data and pass it to the MCAA for further analysis and processing. In some examples, the debug gateway is configured to operate as the control center and can select which nodes will operate as a “pass-through” node (e.g., a passive client/MCAA pair) or will operate as an “activated” node (e.g., an active client/MCAA pair).

In some examples, data that is transmitted sequentially from subblock to subblock may be stored in memory components of the associated nodes. The transmissions may incorporate a first-in-first-out (FIFO) process of saving a portion of the data and then consuming it at a later time. For example, an MCAA (e.g., placed next to a Debug Client) may include a buffer element for storing pre-processed telemetry data or other data. The buffer can be an addressable memory or constructed as a FIFO primitive. The logic/FIFO may store a set of data (e.g., at a predetermined time period or at an agreed upon cadence) at the MCAA producer side of the logic/FIFO. In parallel or at a later time, and at the consumer side of the logic/FIFO, the external control/users can extract the set of data entries via the gateway path that connects to the MCAA. This allows the MCAA to concurrently store data in parallel with an independent data consumer/extractor process. In some examples, analysis applications or other external processes may access and extract the set of data asynchronously.

The sample cadence and commensurate rate of data production and storage can be adjusted to match the rate limit imposed by the process(es) that consume the data. For example, the rate of producing and storing data may be measured using an internal clock frequency of the control bus accessed by the gateway. The clock may help determine the frequency of accessing the data and extracting/transferring the data out. The clock may also help measure the speed of the external SoC interface that is used to interface with the gateway (e.g., JTAG vs. Ethernet vs. USB etc.).

The MCAAs may be distributed throughout the chip, for example, in each of the illustrated subblocks, then used to forward raw or preprocessed data to the debug gateway 156. Illustrative examples of the MCAA of each subblock is illustrated in FIG. 2 and FIG. 3. Debug gateway 156 may connect to the MCAAs to share and aggregate information from the MCAAs. In some examples, the connection from the MCAAs to debug gateway 156 is a serialized connection, potentially mediated through the use of FIFO component(s), following the chained-ring transmission process, rather than routing each connection in parallel.

In some examples, the coupling of the MCAAs at each subblock may access the utilization data and other parametric performance data of that subblock. The utilization data and other parametric performance data may be transmitted to debug gateway 156 for additional processing and analysis.

In the aggregate, the set of individual MCAAs can generate information for the client/MCAA pair that identify a security issue or intrusion of the client through parametric performance data. The data may be generated at run-time. In some examples, the data generated by the combination of the set of individual MCAAs may comprise multi-parametric operations that, in the aggregate, may identify a security issue or intrusion of the set of clients. The aggregated data may help detect aberrant behavior (non-normal) with greater sensitivity, fidelity and accuracy than more commonly employed single-variant approaches to intrusion detection. In some examples, the generation and detection of this data may be part of a security or intrusion detection process that can increase the fidelity and accuracy of the detection algorithms.

FIG. 2 illustrates a SoC with multiple subblocks coupled to multiple MCAAs, in accordance with some examples of the disclosure. In example 200, a debug gateway is included with the SoC. The combined selection of multi-client signals may terminate at the end of the debug chain with the debug gateway. The debug gateway may include control registers, local memory buffers (e.g., for state capture), and data storage elements for storing and subsequent offloading of captured data.

In example 200, the SoC comprises embedded CPUs, debug gateway, a set of debug clients, a set of MCAAs, a set of functions, an execution monitor, a CoreSight® agent, a fabric monitor, JTAG interface, memory controller/DFI PHY, and ethernet MAC/PHY. The debug gateway, debug client, and function may be considered subblocks that can be coupled with the MCAAs. Components of SoC in example 200 are provided for illustrative purposes and should not be limiting to the disclosure.

Additional detail of FIG. 2 is provided in FIG. 3, which illustrates a single subblock coupled to a single MCAA of the SoC, in accordance with some examples of the disclosure. In example 300, debug client 310, MCAA 320, and function 330 are illustrated. The SoC can be constructed of silicon with multiple components as subsystems coupled to the silicon and configured to transmit signals to each other using buses and key signal nets. In some examples, the subsystems in the SoC may not be heterogeneous or able to communicate with each other. The implementation of debug client 310 coupled to MCAA 320 may help generate transparency and exposure to parametric performance data (e.g., generated as internal parametric telemetry data).

Debug client 310 is configured to synchronously capture signals that it monitors from function 330 through a series of selectable multiplexors. Debug client 310 may comprise a dedicated set of gates and logic that are co-located on the chip die next to MCAA 320 and function 330.

Debug client 310 may comprise analyzer module 312 and waveform generator 314. Analyzer module 312 is configured to facilitate trigger setup, storage qualification, and capture of a selection of user instructed data or signals under the monitoring scope of one or more debug clients. The monitored data may be preprocessed by the MCAA prior to storage, which again is mediated by the analyzer block.

Waveform generator 314 is configured to, at the behest of the user, generate predetermined signal waveforms that may be injected at a local subblock level onto one or more of the monitored signals. This could be done through a multiplexing (MUX) structure where the nominal driver of the monitored signal is disconnected from the net and in place waveform generator 314 becomes the driver. Alternatively, the nominal driver of a signal can be passed through the waveform generator and only under certain conditions its logic level manipulated. For example, the Analyzer is configured to trigger and signal waveform generator 314 when signal-X and signal-Z are logic-0 and logic-1 respectively; and on receipt of this trigger signal, waveform generator 314 may be configured to invert signal-Y, or else pass it through.

MCAA 320 is configured to gain runtime access to any subset of monitored signals from debug client 310 or function 330. MCAA 320 may implement different optional capabilities as required by the specific function 330 to which they associate, as described with FIG. 1. MCAA 320 may comprise analysis engine 322 and toggle averaging 324.

Analysis engine 322 is configured to monitor signals associated with a coupled subblock (e.g., debug client 310) simultaneously. In some examples, MCAA 320 may implement a logic state sequencer to implement a cycle process through the set of monitored signals. The cycle process may stall between signal groups as the cycle processes switches from one signal group to the next signal group. The stall may occur for a predetermined dwell period.

Toggle averaging 324 is configured to determine a number of toggles (e.g., activity) for the subblock. The number of toggles may correspond with an individual signal or block-function toggle rate. The toggle rate may be absolute or periodically-averaged. In some examples, dynamic power for the subblock may be extrapolated from the number of toggles. The number of toggles may be a value within a range of a single signal to an arbitrary number of signals (e.g., a few hundred) during a given moving time interval. The number of toggles may correspond an average value using the dwell time. The number of toggles may be stored in a buffer with an optional timestamp derived from an on-chip Real Time Clock (RTC).

Toggle averaging 324 is also configured to determine the number of toggles for the group independent and concurrently with each other. For example, MCAA 320 may be configured to access the local data-multiplexing. MCAA may be configured to perform math functions to calculate and aggregate toggle/activity data. The processed data may be stored and transmitted/offloaded.

Once exported, the toggle data may be post-processed with die placement information. The combination of the toggle data and the die placement information may be used to generate a “heat map,” a time-series utilization curve, or other visual overlay of function utilization as a product of physical placement across the chip.

MCAA 320 may be controllable through a Control and Status Register (CSR) subblock that connects to the SoC fabric. The initiator is either running on a background task on a protected kernel of the embedded CPU (e.g., Linux or OpenBMC) or by external orchestration connected via standard interfaces (e.g., ETH, JTAG, etc.).

Function 330 is configured to execute machine-readable instructions to perform an operation in accordance with the instructions. Examples of the functions described herein are illustrated in FIG. 1 as I2C UART CAN 102, EMMC 104, USB 106, Video 108, MAC 110, DP 112, MC 114, Fabric x8 116, AHB 118, AXI MEM 120, ENC Merge 122, ENC SPI 130, ENC CMDRSP 132, ENC AHB 134, I3C 140, Host 142, PCIE0 144, PCIE1 146, CIF 148, RTC 150, SPI 152, MISC 154, DBG 156, and SoC 170.

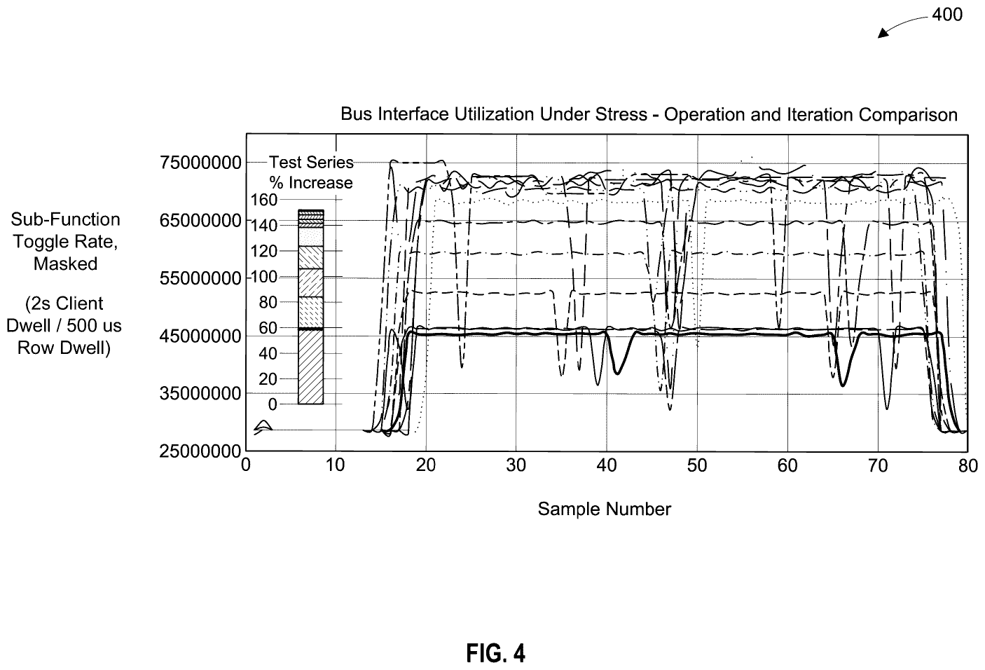

FIG. 4 is a summary of function utilization using MCAA tracking of the subblock operations, in accordance with some examples of the disclosure. In example 400, the summary may show subblock or sub-function toggle rates to illustrate the utilization of each subblock over time. In this example, the utilization of the subblocks were not constant and may have fluctuated over time with respect to the dwell time.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

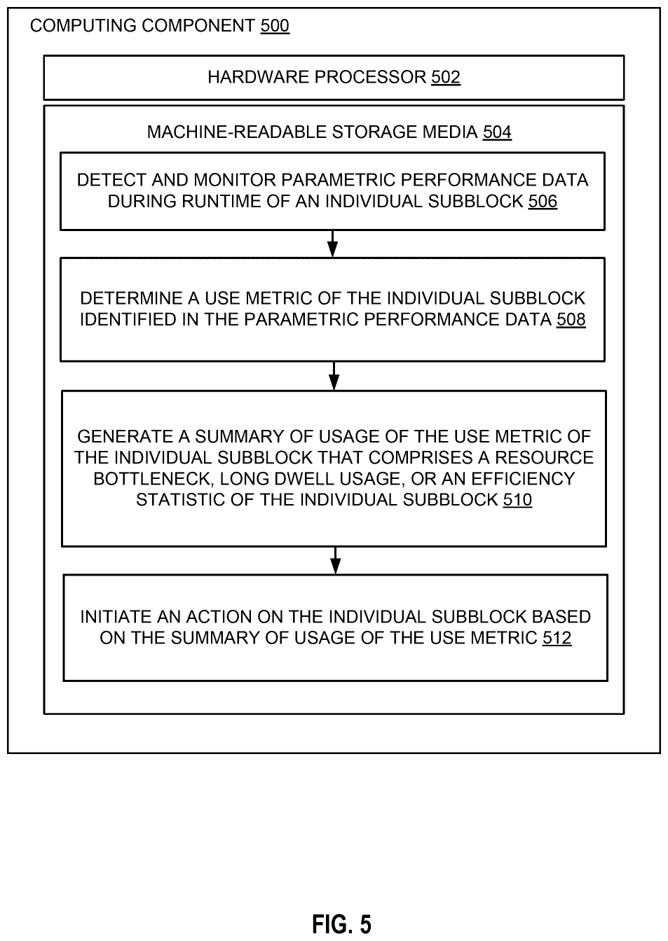

FIG. 5 is an illustrative computing component that may be used to implement various features of examples described in the present disclosure. For example, computing component 500 may be a server computer, a controller, or any other similar computing component capable of processing data. In the example implementation of FIG. 5, computing component 500 includes hardware processor 502 and machine-readable storage medium 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-512, to control processes or operations for various examples described herein. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-512.

Hardware processor 502 may execute instruction 506 to detect and monitor parametric performance data during runtime of an individual subblock. For example, the MCAAs may be coupled with the subblock to help the MCAA gain runtime access to any subset of monitored signals without interrupting the subblock's processing/execution logic. This can allow the MCAA to monitor and interpret parametric performance data. In other words, the MCAAs are incorporated within the framework as leaves of the subblock that can individually execute processing independent of the functions executed in standard operation, including when operations are performed in a FIFO-type system. This allows the MCAAs to determine capabilities and use of each subblock without taking over processing capabilities of the subblock.

Hardware processor 502 may execute instruction 508 to determine a use metric of the individual subblock identified in the parametric performance data. The use metric may comprise quantifiable and measurable values at the silicon-level, including time, transaction throughput, bus latency, resource use (e.g., power, memory, etc.), and other measurable aspects of the performance of the subblock.

Hardware processor 502 may execute instruction 510 to generate a usage summary of the use metric of the individual subblock that comprises a resource bottleneck, long dwell usage, or an efficiency statistic of the individual subblock.

Hardware processor 502 may execute instruction 512 to initiate an action on the individual subblock based on the summary of usage of the use metric. For example, new processing can be assigned based on this analysis. Various actions can be taken based on the monitoring, including identifying and predicting chip hot-spots or underutilized circuits, setting complex threshold triggers for localized frequency scaling or duty cycle modulation (DCM), or enabling external voltage scaling.

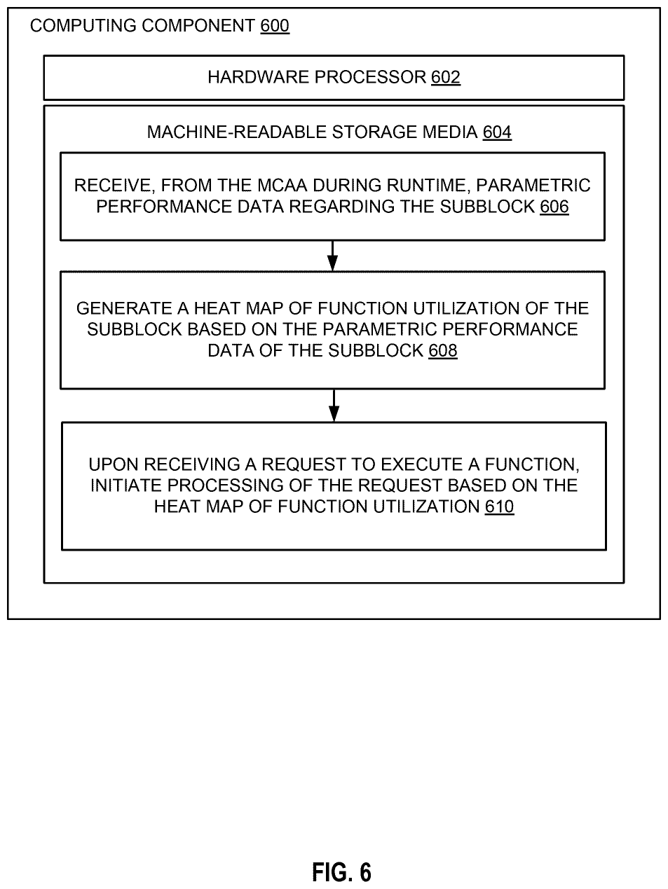

FIG. 6 is an illustrative computing component that may be used to implement various features of examples described in the present disclosure. For example, computing component 600 may be a server computer, a controller, or any other similar computing component capable of processing data. In the example implementation of FIG. 6, computing component 600 includes hardware processor 602 and machine-readable storage medium 604.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-610, to control processes or operations for various examples described herein. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-610.

Hardware processor 602 may execute instruction 606 to receive, from the MCAA during runtime, parametric performance data regarding the subblock. For example, the MCAAs may be coupled with the subblock to help the MCAA gain runtime access to any subset of monitored signals without interrupting the subblock's processing/execution logic. This can allow the MCAA to monitor and interpret parametric performance data. In other words, the MCAAs are incorporated within the framework as leaves of the subblock that can individually execute processing independent of the functions executed in standard operation, including when operations are performed in a FIFO-type system. This allows the MCAAs to determine capabilities and use of each subblock without taking over processing capabilities of the subblock.

Hardware processor 602 may execute instruction 608 to generate a heat map of function utilization of the subblock based on the parametric performance data of the subblock. For example, the parametric performance data is matched to chip placement information to produce a “heat map” of function utilization across the subblocks of the chip (or aggregated across a set of chips).

Hardware processor 602 may execute instruction 610 to initiate processing of the request based on the heat map of function utilization. In some examples, the processing may be initiated based upon receiving a request to execute a function. The heat map and corresponding analysis can determine, for example, which embedded functions are most utilized or which portions of the SoC are available to execute a new function. The MCAAs can monitor which subblocks can individually execute processing independent of the functions executed in standard operation. This allows the MCAAs to determine capabilities and use of each subblock without taking over processing capabilities of the subblock.

In some examples, the heat map and determination of the function utilization can be implemented in a service-based model. For example, clients can pay for use of individual chip components, rather than function/completion-based processing, and use of the chip can be directed to the most underutilized portion of the chip across multiple chips available.

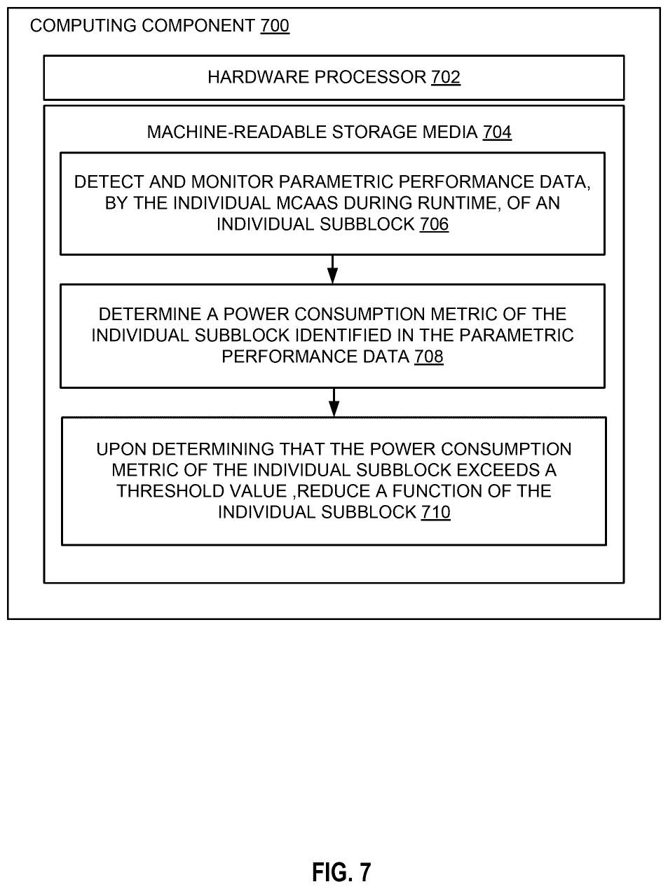

FIG. 7 is an illustrative computing component that may be used to implement various features of examples described in the present disclosure. For example, computing component 700 may be a server computer, a controller, or any other similar computing component capable of processing data. In the example implementation of FIG. 7, computing component 700 includes hardware processor 702 and machine-readable storage medium 704.

Hardware processor 702 may be one or more central processing units (CPUs), semiconductor-based microprocessors, and/or other hardware devices suitable for retrieval and execution of instructions stored in machine-readable storage medium 704. Hardware processor 702 may fetch, decode, and execute instructions, such as instructions 706-710, to control processes or operations for various examples described herein. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 704 may be a non-transitory storage medium, where the term “non-transitory” does not encompass transitory propagating signals. As described in detail below, machine-readable storage medium 704 may be encoded with executable instructions, for example, instructions 706-710.

Hardware processor 702 may execute instruction 706 to detect and monitor parametric performance data by the individual MCAA during runtime individual subblock. For example, the MCAAs may be coupled with the subblock to help the MCAA gain runtime access to any subset of monitored signals without interrupting the subblock's processing/execution logic. This can allow the MCAA to monitor and interpret parametric performance data. In other words, the MCAAs are incorporated with the framework as leaves of the subblock that can individually execute processing independent of the functions executed in standard operation, including when operations are performed in a FIFO-type system. This allows the MCAAs to determine capabilities and use of each subblock without taking over processing capabilities of the subblock.

Hardware processor 702 may execute instruction 708 to determine a power consumption metric of the individual subblock identified in the parametric performance data. The power consumption metric may comprise quantifiable and measurable values at the silicon-level of the power or static vs. dynamic power consumed by each subblock.

In some examples, the MCAA/subblocks may track power usage at a subblock level and identify subblock power usage or function-based power usage. For example, the MCAA framework may determine, for example, (1) where power is being consumed within the SoC and (2) which embedded functions are most utilized, or how to characterize the utilization over time of disparate SoC functions (e.g., Ethernet DMA performance, data path bottlenecks) whilst concurrent processes are executed (e.g., while video frame buffer accesses to the local Dynamic RAM (DRAM) are in flight).

Hardware processor 702 may execute instruction 710 to reduce a function of the individual subblock, and in some examples, the function may be reduced upon determining that the power consumption metric of the individual subblock exceeds a threshold value. The threshold value may be a predetermined value or dynamic based on the power consumption metrics of other subblocks on the SoC.

In some examples, a multi-step threshold and response process can be implemented. For example, a consumption metric associated with the system is identified, including a metric related to power, use, performance, or other metric. Upon determining that the consumption metric is below a first/low threshold, the process may increase a function of the individual subblock. In other examples, the function may be otherwise adjusted based on the metric being between two thresholds.

In some examples, using the above-noted information, a controller may instruct the MCAA(s) to disable one or more associated functions, or the MCAA may independently execute operations to disable various functions. The MCAA accomplishes this through assertion of clock-gating elements and/or disablement of register enable pins. Some implementations allow power wells to be disabled in a similar fashion, intelligently reducing device power utilization by dynamically culling unused functional branches.

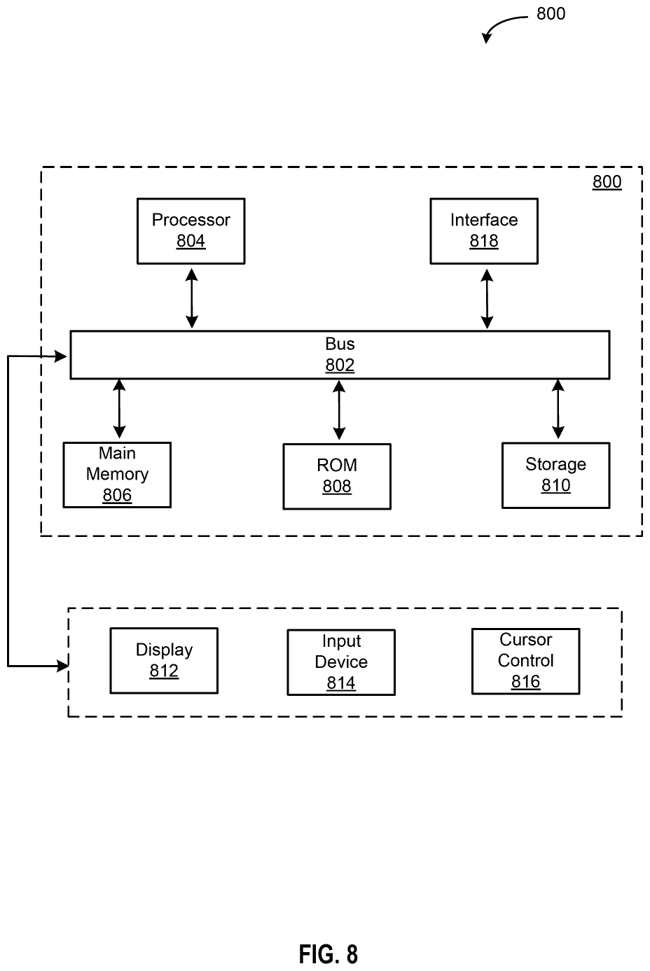

FIG. 8 depicts a block diagram of an example computer system 800 in which several of the embodiments described herein may be implemented. The computer system 800 includes a bus 802 or other communication mechanism for communicating information, one or more hardware processors 804 coupled with bus 802 for processing information. Hardware processor(s) 804 may be, for example, one or more general purpose microprocessors.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. In some embodiments, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

The computer system 800 also includes interface 818 coupled to bus 802. Interface 818 provides a two-way data communication coupling to one or more network links that are connected to one or more local networks. For example, interface 818 may be an integrated services digital network (ISDN) card, cable modem, satellite modem, or a modem to provide a data communication connection to a corresponding type of telephone line. As another example, interface 818 may be a local area network (LAN) card to provide a data communication connection to a compatible LAN (or WAN component to communicate with a WAN). Wireless links may also be implemented. In any such implementation, interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 818, which carry the digital data to and from computer system 800, are example forms of transmission media.

The computer system 800 can send messages and receive data, including program code, through the network(s), network link and interface 818. In the Internet example, a server might transmit a requested code for an application program through the Internet, the ISP, the local network and interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system on chip (SoC) comprising:
a set of subblocks; and
a set of Monitor Control and Analysis Agents (MCAAs) coupled to individual subblocks of the set of subblocks, wherein individual MCAAs of the set of MCAAs are configured to:
detect and monitor parametric performance data, during runtime of the SoC, of an individual subblock of the set of subblocks,
determine a use metric of the individual subblock identified in the parametric performance data during runtime of the SoC,
generate a summary of usage of the use metric of the individual subblock of the set of subblocks of the individual subblock, and
initiate an action on the individual subblock based on the summary of usage of the use metric.

2. The SoC of claim 1, wherein the individual MCAAs of the set of MCAAs are further configured to:
determine that the summary of usage of the use metric comprises a resource bottleneck, long dwell usage, or an efficiency statistic of the individual subblock; and
initiating a prediction process, by the individual MCAAs, that identifies chip hot-spots or underutilized circuits.

3. The SoC of claim 1, wherein the individual MCAAs of the set of MCAAs are further configured to:
determine that the summary of usage of the use metric comprises a resource bottleneck, long dwell usage, or an efficiency statistic of the individual subblock; and
initiating a trigger process, by the individual MCAAs, that executes localized frequency scaling or duty cycle modulation (DCM).

4. The SoC of claim 1, wherein the individual MCAAs of the set of MCAAs are further configured to:
determine that the summary of usage of the use metric comprises a resource bottleneck, long dwell usage, or an efficiency statistic of the individual subblock; and
based on the summary of usage, enabling external voltage scaling of the functions associated with respective individual MCAAs of the set of MCAAs.

5. The SoC of claim 1, wherein:
the set of MCAAs are autonomous and individually programmable,
the set of MCAAs are placed in an interconnected ring around the SoC configured to utilize and monitor functionality of the individual subblocks, and
placement of the set of MCAAs in the interconnected ring around the SoC enables coupled and autonomous communications between individual MCAAs of the set of MCAAs and the individual subblocks, and
the communications are routed sequentially in a chain ring format to the set of MCAAs within the interconnected ring.

6. The SoC of claim 5, further comprising:
a Control and Status Register (CSR) subblock, wherein the set of MCAAs are controllable through the CSR subblock integrated within the SoC.

7. A system on chip (SoC) comprising:
a subblock;
a Monitor Control and Analysis Agent (MCAA) coupled to the subblock; and
a processor configured to:
receive, from the MCAA, during runtime of the SoC, parametric performance data regarding the subblock,
wherein the parametric performance data regarding the subblock comprises internal parametric telemetry data for the subblock;
enable generation of a time-series utilization curve of function utilization of the subblock, by an external processor of the SoC, based on the parametric performance data of the subblock; and
upon receiving a request to execute a function, initiate processing of the request based on the time-series utilization curve of function utilization.

8. The SoC of claim 7, wherein the processor is further configured to:
upon determining that a use metric of the time-series utilization curve corresponding to the subblock exceeds a threshold value, assign the request to execute the function to a second subblock; and
enable regeneration of the time-series utilization curve using updated parametric performance data from the MCAA during runtime.

9. The SoC of claim 7, wherein:
the set of MCAAs are autonomous and individually programmable,
the set of MCAAs are placed in a ring around the SoC configured to utilize and monitor functionality of the individual subblocks, and
placement of the set of MCAAs in the ring around the SoC enables coupled and autonomous communications between individual MCAAs of the set of MCAAs and the individual subblocks, and
the communications are routed sequentially to the set of MCAAs in a serialized, daisy-chain format within the ring.

10. The SoC of claim 9, further comprising:
a Control and Status Register (CSR) subblock, wherein the set of MCAAs are controllable through the CSR subblock that connects to the SoC.

11. The SoC of claim 7, wherein the parametric performance data comprises silicon-level data that comprises time data, cost data, or resource utilization data.

12. A system on chip (SoC) comprising:
a set of subblocks;
a set of Monitor Control and Analysis Agents (MCAAs) coupled to individual subblocks of the set of subblocks; and
a processor configured to:
detect and monitor parametric performance data, by the individual MCAAs during runtime of the SoC, of an individual subblock of the set of subblocks,
determine a consumption metric of the individual subblock identified in the parametric performance data, and
upon determining that the consumption metric of the individual subblock exceeds a threshold value, initiate an action of the individual subblock.

13. The SoC of claim 12, wherein the consumption metric is a power consumption metric that exceeds the threshold, and the action is to increase a function of the individual subblock that alters the power consumption metric.

14. The SoC of claim 12, wherein the consumption metric is a use consumption metric that exceeds the threshold, and the action is to increase a function of the individual subblock that alters the use consumption metric.

15. The SoC of claim 12, wherein the consumption metric is a performance consumption metric that exceeds the threshold, and the action is to increase a function of the individual subblock that alters the performance consumption metric.

16. The SoC of claim 12, wherein the function or associated metrics of the function are modulated by the MCAA of the individual subblock reducing activity of the function of the individual subblock, and wherein the MCAA operates independently.

17. The SoC of claim 12, wherein the function is reduced by a controller of the SoC instructing the MCAA of the individual subblock to modulate the function of the individual subblock.

18. The SoC of claim 12, wherein the function is modulated by adjusting a clock-gating element.

19. The SoC of claim 12, wherein the function is modulated by de-assertion of one or more associated register enable pins.

20. The SoC of claim 12, wherein the processor is further configured to:
determine the parametric performance data comprises multi-parametric operations across a set of individual MCAAs; and
initiate security or intrusion detection towards the functions associated with the set of individual MCAAs.
